(19) United States
(12) Patent Application Publication
(10) Pub. No.: US 2008/0164730 A1
(43) Pub. Date: Jul. 10, 2008

(54) INSERT FOR VEHICLE SEAT HEAD RESTRAINT

(75) Inventors: Joseph Watson, Lincoln Park, MI (US); Zbigniew J. Orzelski, Bloomfield Hills, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/620,482

(22) Filed: Jan. 5, 2007

(51) Int. Cl. B60R 21/055

(52) U.S. Cl. 297/216.12

(57) ABSTRACT

An insert for a head restraint for a vehicle seat is disclosed with a body formed from a structural material that is sized to be inserted within a foam layer of a head restraint bun. The body is adapted to be mounted to a seat back of the vehicle seat. The body has a contact surface for receiving a head of an occupant, with a central depression for providing an increased contact area to the head of the occupant. In another embodiment, an insert is provided with a body to be inserted within a foam layer of a head restraint bun of a head restraint. The body has a front head contact surface and a forward inclined recess formed in a rear side to receive an armature of a vehicle seat and to prevent disassembly.

### BACKGROUND OF THE INVENTION

1. Field of the Invention

The invention relates to vehicle head restraints.

2. Background Art

Head restraints for vehicle seats are utilized for providing comfort to an occupant and also for the safety of the occupant. For example, in the occurrence of a rear impact, the occupant's head impacts the head restraint. Thus, safety and comfort are design considerations that are factored concurrently.

Vehicle head restraints often include a head restraint bun, which provides the structural support to the occupant's head in both the impact conditions and ordinary operations. In order to provide comfort to the occupant, the head restraint bun typically includes a layer of soft foam for padded comfort.

In recent years, a cost effective design that optimizes both structure and comfort has been employed in some head restraints in European vehicle seats, which utilize an expanded foam insert within the head restraint bun. The insert is commonly made of an expandable structural foam that is subsequently covered with a soft foam layer for providing comfort.

In Dec. 22, 2004, the National Highway Traffic Safety Administration of the United States Department of Transportation released a new Laboratory Test Procedure for Federal Motor Vehicle Safety Standard (FMVSS) 202aS, that includes “backset retention” and “height retention” requirements. The backset retention and height retention requirements limit the energy absorption of the head restraint.

### SUMMARY OF THE INVENTION

One embodiment of the invention provides an insert for a head restraint for a vehicle seat with a body formed from a structural material. The body is sized to be inserted within a foam layer of a head restraint bun. The body is adapted to be mounted to a seat back of a vehicle seat. The body has a head contact surface for receiving a head of an occupant. The body has a central depression formed in the head contact surface for providing an increased contact area to the head of the occupant.

Another embodiment of the present invention is an insert for a head restraint for a vehicle seat with a body formed from a structural material. The body is sized to be inserted within a foam layer of a head restraint bun. The body has a front head contact surface for receiving a head of an occupant. The body has a recess formed in a rearside of the body opposed from the head contact surface. The recess has a transverse region for receiving a transverse portion of an armature, which is inclined in a forward direction for retention of the armature during occupant imparted loads from the forward or rearward directions.

Another embodiment of the present invention is a method for forming a head restraint. The method includes molding a head restraint insert from a structural material with a head contact surface and a depression in the head contact surface for providing an area of contact to a head of an occupant, and with a forward inclined recess in a back surface of the insert for retaining the insert upon an armature. A tubular armature is formed and inserted into the recess. A soft foam is insert-molded about the head restraint insert and a portion of the armature.

The above embodiments and other embodiments, advantages, benefits, features, aspects, and objects of the invention are apparent in the attached figures and in the detailed description of embodiments of the invention below.

### BRIEF DESCRIPTION OF THE DRAWINGS

FIG. 1 is a perspective view of a vehicle seat in accordance with the present invention;

FIG. 2 is a front fragmentary perspective view of a head restraint in accordance with the present invention;

FIG. 3 is a side fragmentary perspective view of the head restraint of FIG. 2;

FIG. 4 is an enlarged perspective view of an insert of the head restraint of FIG. 2;

FIG. 5 is a rear perspective view of the head restraint insert of FIG. 4;

FIG. 6 is a rear perspective view of the head restraint of FIG. 2; and

FIG. 7 is a section view of the head restraint of FIG. 2.

### DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

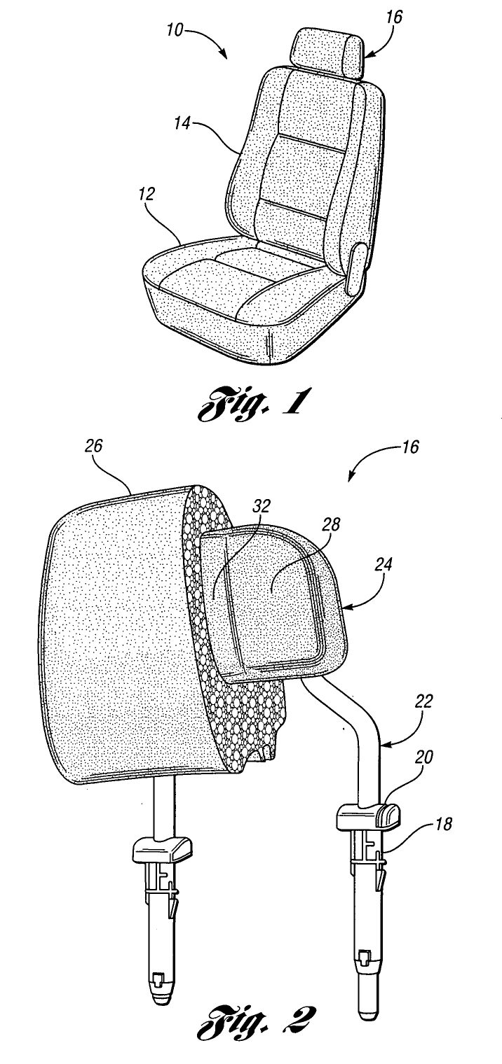

Referring now to FIG. 1, a vehicle seat assembly is illustrated in accordance with an embodiment of the present invention and is referenced generally by numeral 10. The vehicle seat 10 may be a driver seat, or any other passenger seat, such as a first row seat, a second row seat or any subsequent row seat. The vehicle seat 10 includes a seat cushion and track assembly 12 for seating an occupant thereupon. The seat cushion and track assembly 12 is secured to a floor of the vehicle. The vehicle seat 10 also includes a seat back assembly 14 extending from the seat cushion and track assembly 12 for supporting a torso of the occupant. A head restraint 16 is mounted to the seat back assembly 14 for supporting a head of the occupant for comfort of the occupant when the occupant rests his or her head against the head restraint 16. The head restraint 16 also enhances safety to the occupant by supporting the head of the occupant during an impact condition to minimize the probability and severity of whiplash. Although an individual vehicle seat 10 is illustrated in the embodiment of FIG. 1, the invention contemplates that any size seat 10 may be utilized, such as a bench seat, which utilizes one or more head restraints 16.

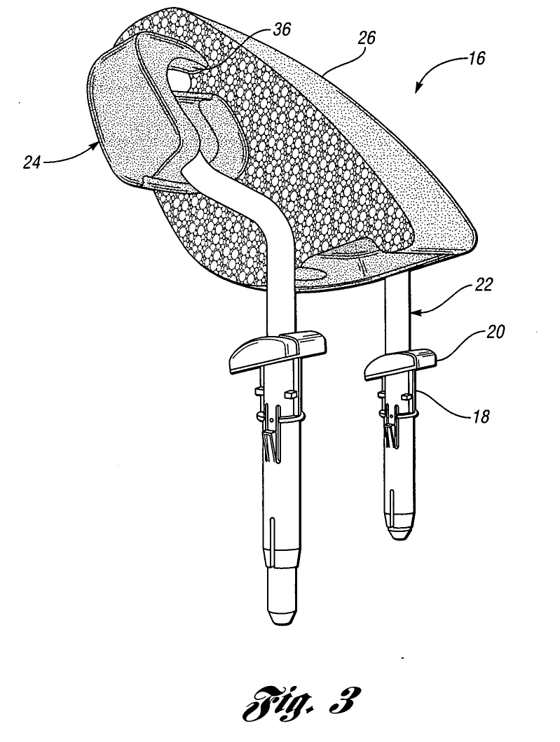

Referring now to FIGS. 2 and 3, the head restraint 16 is illustrated in further detail with a trim cover removed. The head restraint 16 includes a pair of sleeves 18, which are mounted within the seat back assembly 14. The sleeves 18 each include a cap 20 that is displaced upon the top of the seat back assembly 14. An armature 22 is provided by a bent tube or rod with a pair of terminal ends each disposed within one of the sleeves 18, for mounting the armature 22 to the seat back assembly 14. One of the caps 20, in one embodiment, includes a latch mechanism for adjusting the height of the head restraint 16.

The head restraint 16 includes an insert 24 mounted to the armature 22. The insert is formed from a rigid or impact absorbent material for absorbing an impact imparted upon the insert 24 by, for example, the head of the occupant. In at least one embodiment, the impact absorbent material is a foam. Expandable polypropylene is a suitable foam for fabricating the insert 24, for example. The expanded polypropylene may be provided with a density of forty-five to sixty kilograms per cubic meter, to provide a light and cost effective insert that is suitable for the applicable design requirements. In at least another embodiment, the insert is formed from expandable polystyrene. In yet another embodiment, the insert is fabricated from polyurethane foam. In at least another embodiment, the insert is formed from blow-molded plastic. Of course other suitable materials are contemplated within the spirit and scope of the invention.

The head restraint 16 of the depicted embodiment also includes a soft outer foam layer 26 that is molded about the insert 24 and a portion of the armature 22. In one embodiment, the soft outer foam layer 26 collectively forms a head restraint bun with the insert 24. The foam outer layer 26 is illustrated fragmented in FIGS. 2 and 3 for revealing the relative location of the foam outer layer 26 and the insert 24. The foam outer layer 26 may be formed from a porous foam. The foam outer layer 26 provides padding about the insert 24 for comfort and padding to the occupant. Additionally, the foam outer layer 26 provides the overall shape of the head restraint bun of the head restraint 16 while providing compliancy supported from within by the insert 24. Although one sufficient material for the foam outer layer 26 is disclosed, various suitable materials are contemplated within the spirit and scope of the present invention.

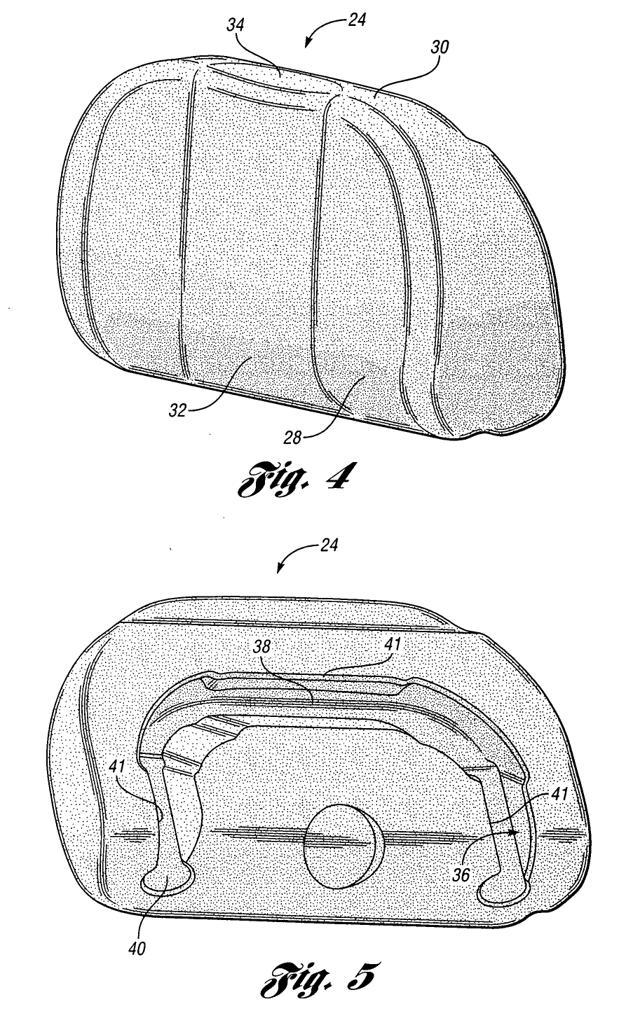

Referring now to FIG. 4, the insert 24 is illustrated as an individual component. The insert 24 is sized to receive and absorb an impact of the head of the occupant, in applicable impact conditions. One such impact condition may be a rear end impact to the vehicle. Another impact may be a front end impact where the occupant rebounds from a belt restraint and into the vehicle seat 10 and a second row unbelted occupant impacts the rear surface of the head restraint 16.

The insert 24 has a generally planar forward facing head contact surface 28 and an upward facing head contact surface 30. During an impact condition, the occupant's head compresses the foam outer layer 26 and then impacts the insert 24 at one of the head contact surfaces 28, 30. An occupant's head is typically round and therefore to provide an increased contact area to the head of the occupant, a central depression 32 is formed within the forward contact surface 28. Likewise, a central depression 34 is formed within the upward contact surface 30. The depressions 32, 34 are arcuate and recessed within the respective contact surfaces 28, 30 to provide an increased contact area to the head of the occupant. By providing an increased contact area rather than a point contact, the load of the impact is distributed over a larger area resulting in less displacement or deformation to the contacting surfaces of the insert 24. The reduced displacement to the insert 24 results in less damage to material of the insert 24.

The insert 24 has a width, which is the lateral dimension along the forward contact surface 28. The insert 24 also has a height, which is the upright dimension of the forward contact surface 28. To accommodate occupants of varying height, and/or to accommodate various height adjustments of the head restraint 16, the central depression 32 bisects the width of the insert 24 and extends along the height. Thus, the forward depression 32 is a cylindrical depression along the centerline of the depicted insert 24 embodiment. Likewise, the upward contact surface 30 has a thickness provided in a fore/aft dimension of the insert 24. The upward depression 34 bisects the width of the upward contact surface 30 and extends along the thickness to provide the area of contact along upward contact surface 30. The upward depression 34 is also cylindrical in at least one embodiment and is formed along the centerline of the upward contact surface 30.

The insert 24 of the depicted embodiment withstands the height retention and backset retention tests of the FMVSS 202aS of Dec. 22, 2004, which is incorporated in its entirety by reference herein, without necessitating an increased density and cost of the insert 24. Flat contact surfaces without depressions result in undesirable displacement when subjected to these tests. The increased contact areas provided by the depressions 32, 34 of the insert 24, distribute the load, resulting in improved performance and reduced displacement values within the limitations set by the height retention and backset retention tests. One suitable dimension for withstanding these tests is that the depressions 32, 34 may be provided with a radius of eighty-two and one half millimeters. Although one exemplary dimension is provided other suitable dimensions are contemplated within the spirit and scope of the present invention.

Referring now to FIG. 5, a rear side of the insert 24 is illustrated. The insert 24 is provided with a trench 36 formed therein for receiving and retention to the armature 22. The trench 36 is generally in the shape of an inverted ‘U’ with a transverse region 38 and a pair of upright regions 40 for receiving corresponding portions of the armature 22. The transverse and upright regions 38, 40 are profiled to extend about more than one half of the diameter of the armature 22 with a retaining projection 41. Thus, the transverse and upright regions 38, 40 provide an interference fit with the armature 22 thereby fastening and retaining the insert 24 to the armature 22.

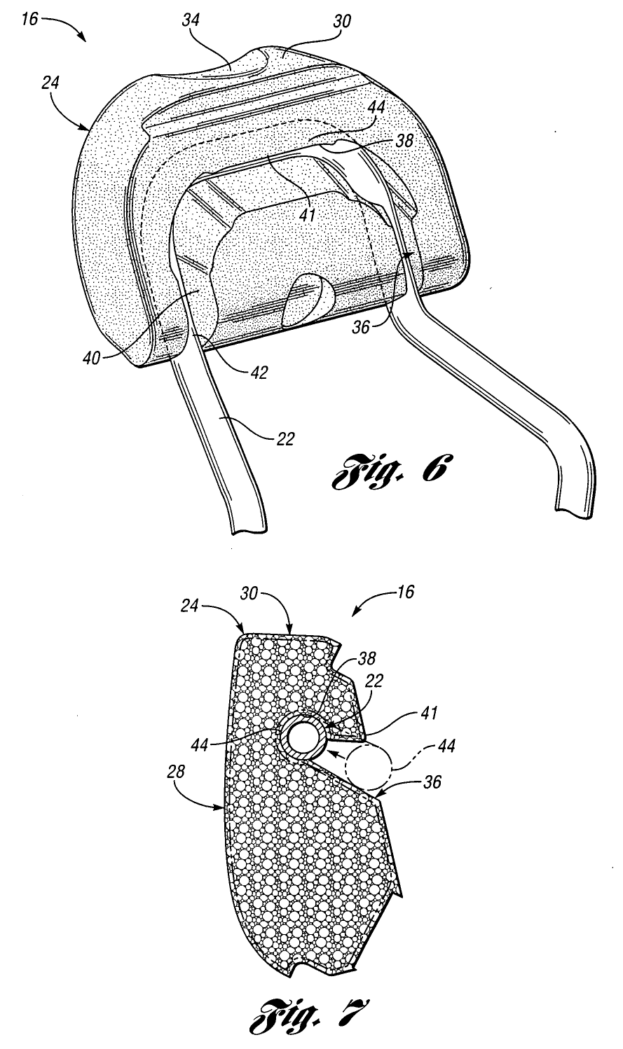

Referring now to FIG. 6, the insert 24 is illustrated assembled with the armature 22. The armature 22 includes corresponding upright portions 42 and a transverse portion 44, which are received within the upright regions 40 and the transverse regions 38 of the trench 36 respectively.

Referring now to FIG. 7, the insert 24 and armature 22 are illustrated in cross section through the transverse region 38 of the trench 36 of the insert 24 and through the transverse portion 44 of the armature 22. The insert 24 is illustrated as a foam insert 24 in cross-section according to at least one embodiment. In an alternative embodiment, the insert 24 is blow-molded and therefore has a wall thickness, depicted by the phantom line, with a hollow interior cavity.

During insertion of the armature 22 into the trench 36, which is illustrated by the armature transverse portion 44 in phantom (pre-insertion) and the armature transverse portion 44 in solid (inserted), the interference projection 41 provides a substantially increased retention between the insert 24 and the armature 22 in the installed position. This retention prevents dislodging of the insert 24 from the armature 22 when a forward force is applied at the top/rear region of the head restraint 16. In another embodiment, a net fit is provided at the installed position, with interference at intermediate positions during assembly, thereby preventing disassembly.

The transverse region of the trench 36 is inclined in a forward direction. Upon application of a load to the insert 24, such as by the head of the occupant, in a rearward direction, the trench 36 maintains the retention of the insert 24 upon the armature 22. Likewise, application of a load in a forward direction, such as a load imparted from a rear passenger during ingress and egress does not disengage the insert 24 from the armature 22. Such a load is applied generally at the top of the head restraint 16 above the incline of the trench 36 so that the trench 36 retains the insert 24 upon the armature 22. Locating the retaining projection 41 at the top and rear of the trench 36 with the incline provides sufficient retention of the insert upon the armature in a cost-effective manner.

Moreover, a low cost and lightweight insert 24 for a head restraint is provided that withstands applicable testing and mounts and retains the insert 24 to the armature 22 without requiring additional components, such as fasteners, adhesives or the like that would add to the cost and weight of the head restraint 16.

In one embodiment, the insert is molded from an expandable foam with the contact surfaces 28, 30, the depressions 32, 34 and the trench 36 molded into the body of the insert 24. The armature 22 is formed from a tube that is bent, cold formed or otherwise shaped to mount the insert 24 and foam outer layer 26 to the seat back assembly 14. The armature 22 is inserted into the trench 36 of the insert 24. Due to the interference fit of the trench 36, the armature 22 must be pressed into the trench 36 in one embodiment. Subsequently, the insert 24 and a portion of the armature 22 are disposed within a mold and the foam outer layer 26 is molded about the insert 24 thereby collectively providing the head restraint bun for the head restraint 16.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An insert for a head restraint for a vehicle seat comprising a body formed from a structural material, the body being sized to be inserted within a foam layer of a head restraint bun, the body being adapted to be mounted to a seat back of a vehicle seat, the body having a head contact surface for receiving a head of an occupant, and the body having a central depression formed in the head contact surface for providing an increased contact area to the head of the occupant.

2. The head restraint insert of claim 1 wherein the head contact surface further comprises a forward facing head contact surface and an upward facing head contact surface, and wherein the body has a recess formed in a rear side of the body opposed from the forward facing head contact surface, the recess having a transverse region for receiving a transverse portion of an armature, the recess transverse region being inclined in a forward direction for retention of the armature during occupant imparted loads from the forward or rearward directions.

3. The head restraint insert of claim 1 wherein the depression is generally arcuate.

4. The head restraint insert of claim 1 wherein the depression has a radius of approximately eighty-two and one half millimeters.

5. The head restraint insert of claim 1 wherein the insert is formed from foam.

6. The head restraint insert of claim 1 wherein the insert is formed from expanded polypropylene.

7. A head restraint for a vehicle seat comprising:
the head restraint insert of claim 1; and
a foam layer disposed about the insert for providing a head restraint bun collectively with the insert, the foam layer being formed of a material that is softer than the insert for providing padding and comfort to the head of the occupant, whereby application of a predetermined impact load to the foam layer compresses the foam layer and imparts the impact load to the insert.

8. A vehicle seat comprising:
a seat bottom;
a seat back extending from the seat bottom;
an armature mounted to the seat back; and
the head restraint of claim 7, wherein the head restraint is mounted to the armature.

9. The head restraint insert of claim 1 wherein the head contact surface is forward facing.

10. The head restraint insert of claim 9 wherein the head contact surface has a width and a height and the depression bisects the width.

11. The head restraint insert of claim 10 wherein the depression extends along the height of the head contact surface.

12. The head restraint insert of claim 1 wherein the head contact surface is upward facing.

13. The head restraint insert of claim 12 wherein the head contact surface has a width and a thickness and the depression bisects the width.

14. The head restraint insert of claim 13 wherein the depression extends along the thickness of the head contact surface.

15. An insert for a head restraint for a vehicle seat comprising a body formed from a structural material, the body being sized to be inserted within a foam layer of a head restraint bun, the body having a front head contact surface for receiving a head of an occupant, and the body having a recess formed in a rear side of the body opposed from the front head contact surface, the recess having a transverse region for receiving a transverse portion of an armature, the recess transverse region being inclined in a forward direction for retention of the armature during occupant imparted loads from the forward or rearward directions.

16. The head restraint insert of claim 15 wherein the recess is sized to receive with an interference fit an armature of a vehicle seat for mounting the insert to the vehicle seat.

17. A head restraint comprising:
an armature adapted to be mounted to a vehicle seat, the armature having a transverse portion;
the head restraint insert of claim 16 wherein the recess transverse region is mounted upon the armature transverse portion; and
a foam layer disposed about the insert for providing a head restraint bun collectively with the insert, the foam layer being formed of a material that is softer than the insert for providing padding and comfort to the head of the occupant.

18. A method for forming a head restraint comprising:
molding a head restraint insert from a structural material with a head contact surface and a depression in the head contact surface for providing an increased contact area to a head of an occupant and with a forward inclined recess in a back surface of the insert for retaining the insert upon an armature;
forming a tubular armature;
inserting the armature into the recess; and
insert-molding a soft foam about the head restraint insert and a portion of the armature.

19. The method of claim 18 further comprising:
bending a transverse portion into the tubular armature; and
inserting the armature transverse portion into the transverse region of the head restraint insert recess with an interference fit.

20. A head restraint formed from the method of claim 18.
